(19) United States
(12) Patent Application Publication
(10) Pub. No.: US 2006/0089867 A1
(43) Pub. Date: Apr. 27, 2006

(54) Inventory control system and method

(76) Inventors: Toshiyuki Sakuma, Kawasaki (JP); Tomoyuki Aoki, Yokohama (JP); Yuichi Kaneko, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/255,151

(22) Filed: Oct. 21, 2005

(30) Foreign Application Priority Data
Oct. 22, 2004 (JP) 2004-308774

(51) Int. Cl. G06Q 99/00; G05B 19/418

(52) U.S. Cl. 705/8; 705/1

(57) ABSTRACT

The invention suppresses stock excess or deficiency of circulation items through a life cycle of the circulation items. In an inventory control system, an information processing device calculates an index (KPI) which shows a current phase of a circulation item from actual data of the circulation item, at predetermined timing (S1101) . After that, the information processing device compares a shift condition stored in a code storage area with KPI, and in case that KPI satisfies the shift condition, it judges that a phase of the circulation item is changed (S1103). Here, when a user inputs renewal permission of safety stock quantity of circulation item (S1104), the information processing device calculates safety stock quantity of circulation items in the shifted phase (S1107).

### BACKGROUND OF THE INVENTION

This invention relates to an inventory control technology where a safety stock is managed for absorbing uncertainty of demand fluctuation and a refilling period, depending on a life cycle of a circulation item.

Generally, safety stock quantity is given by the following theoretical formula (1).
Safety stock Quantity=K×\sqrt{T}×α (1)

Here, K designates a safety coefficient which is defined according to probability of stock exhaust, and T designates a target period which requires to absorb an error of demand projection (in case of a method for ordering at regular intervals, a planning cycle time, transport lead time to an inventory point/production lead time, and lead time which is taken by planning), and σ designates disperison of past demand (standard deviation).

As a technology where such safety stock is dynamically changed as well as renewal of the target period (a planning cycle time, transport lead time to an inventory point/production lead time, and lead time which is taken by planning), a technology, which is described in for example, Japanese Patent Laid-open Publication No. 2004-70612, is known.

Meanwhile, in addition to that, as technologies regarding management of safety stock, technologies, which are described in Japanese Patent Laid-open Publication No. 2004-102367 and Hitachi Review, March 2004 version, P33 through P36, are known.

However, if a utilization method of the above-described technologies is wrong, there is such a possibility that there occurs stock excess or shortage in some stage of a life cycle (from market introduction initial stage until sales termination) of circulation items (finished goods, parts, semi-finished goods, in process item (work-in-process), raw materials, etc.)

### SUMMARY OF THE INVENTION

An object of the invention is to prevent occurrence of excess or shortage of stocks, in each stage of a life cycle of circulation item.

The invention provides

an inventory control system which manages inventory quantity of circulation products, and has

storing means in which phase identification information representing a current phase of the circulation products, and a shift condition to each phase in a life cycle of the circulation products are stored,

arithmetic processing means which calculates an index for judging that a phase, which is represented by the phase identification information, is shifted to its next phase, from actual showing data regarding circulation of the circulation products, compares the index with the shift condition, and detects a change of a phase of the circulation products, in case that the index satisfies the shift condition, and

input accepting means which accepts an input of renewal permission of safety stock quantity of the circulation products, in case that the arithmetic processing means detected the change, and

in which

the arithmetic processing means

executes renewal of the phase identification information stored in the storing means, by phase identification information which represents a shifted phase, and calculation of safety inventory quantity of the circulation products, in the shifted phase, as to the base, when the input accepting means accepts the input of renewal permission.

According to the invention, it is possible to suppress stock excess or deficiency, through a life cycle of a circulation item.

### BRIEF DESCRIPTION OF THE DRAWINGS

FIG. 1 is a view which shows a phsycal distribution network to which an inventory control system according to one embodiment of the invention is applicable.

FIG. 2 is a view which shows a schematic configuration of the inventory control system according to to one embodiment of the invention.

FIG. 3 is a block diagram showing hardware configuration of an inventory management system according to one embodiment of the invention.

FIG. 4 is a functional block diagram of the inventory management system according to one embodiment of the invention.

FIG. 5 is a view for explaining a data configuration of master data of a phase shift.

FIG. 6 is a view for explaining a data configuration of link master data.

FIG. 7 is a view for explaining a data configuration of a base master data.

FIG. 8 is a view for explaining a data configuration of an inventory actual data table.

FIG. 9 is a view for explaining a data configuration of a demand actual data table.

FIG. 10 is a view for explaining a data configuration of a supply actual data table.

FIG. 11 is a flow chart of inventory control processing according to one embodiment of the invention.

FIG. 12 is a view for explaining a calculation formula of safety stock quantity which is used in inventory control processing according to one embodiment of the invention.

FIG. 13 is a flow chart showing processing of S1107 in FIG. 11.

FIG. 14 is a view which shows a change of safety stock quantity at a base, before and after inventory control processing.

FIG. 15 is a view for explaining an application example of an inventory control system according to one embodiment of the invention.

FIG. 16 is a view which shows safety stock quantity in a first phase.

FIG. 17 is a view which shows safety stock quantity in a second phase.

FIG. 18 is a view which shows safety stock quantity in a third phase.

FIG. 19 is a view which shows safety stock quantity in a fourth phase.

### DETAILED DESCRIPTION OF THE PREFERRED EMBODIMENTS

Hereinafter, one embodiment according to the invention will be described over referring to accompanying drawings.

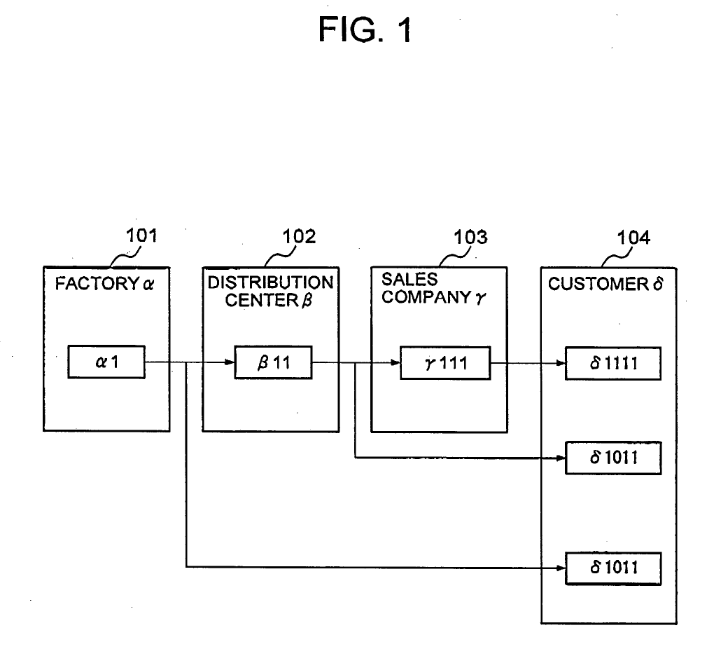

Firstly, with reference to FIG. 1, a brief overview of a model of a physcal distribution network, to which an inventory control system according to this embodiment is applicable, will be described.

As physcal distribution of items from a factory 101 to a customer 104, there are plural kinds of flows as follows. A first flow is a flow which runs from the factory 101 to the customer 104 through a distribution center 102 and a sales company 103, and a second flow is a flow which runs from the factory 101 to the customer 104 through the distribution center 102, and a third flow is a flow which runs from the factory 101 directly to the customer 104. Circulation items (finished goods, parts, semi-finished goods, in process goods (work-in-process), raw materials, etc.) in such physical distribution network are hereinafter called as “item”.

Generally, a life cycle (a period from market introduction initial stage until sales termination) of a item is divided into a first phase which is an introduction period of item into a market, a second phase which is a propagation period of item into a market, a third phase which is a maturation phasein which item is acquiring users, and a fourth phase which is a decline phase leading up to sales termination of item. Among the first through the third flows shown in FIG. 1, for example, the first flow corresponds to a flow of item in the first and second phases, and the second flow corresponds to a flow of item in the third phase, and the third flow corresponds to a flow of item in the fourth phase.

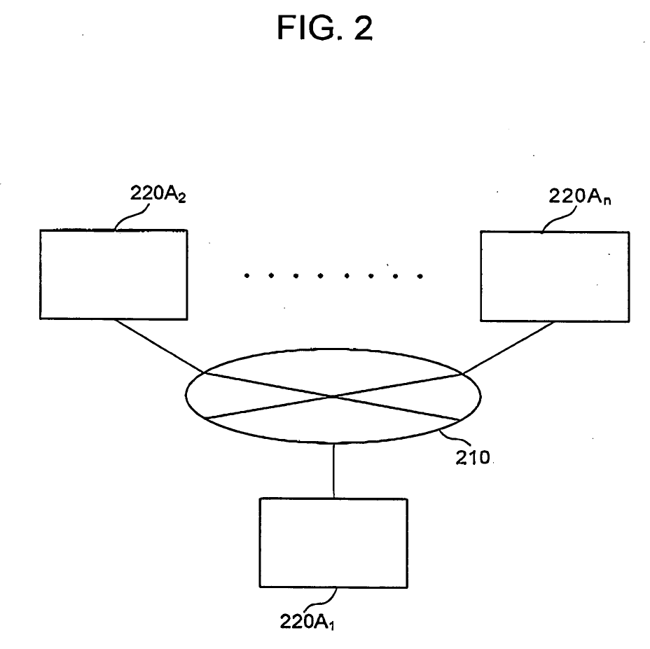

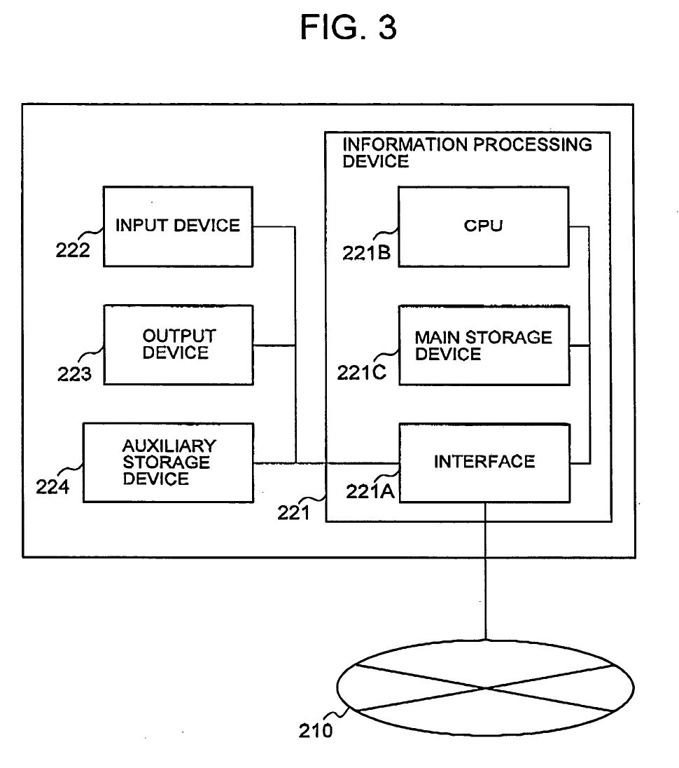

Next, refering to FIGS. 2 and 3, a schematic configuration of an inventory control system according to this embodiment, to which such physical distribution network is applicable, will be described.

As shown in FIG. 2, the inventory control system includes a plurality of subsystems 220A₁, 220A₂ . . . , 220Aₙ connected through a network 210.

Each subsystem 220A₁, 220A₂, . . . , 220Aₙ has a hardware configuration in which a program is executable, respectively. Concretely speaking, the subsystem has, as shown in FIG. 3, an information processing device 221, an input device (keyboard, mouse, etc.) 222 which accepts an input from a user, an output device (display etc.) 223 which outputs various information, an auxiliary storage device 224 in which various programs and data are stored, and so on, respectively. Here, the information processing device 221 has an interface 221A to which a peripheral device (the auxiliary storage device 224, the input device 222, the output device 224) is connected, a main storage device 221C, a central processing unit (CPU) 221B which executes a program loaded from the auxiliary storage device 224 etc. to the main storage device 221C, and so on.

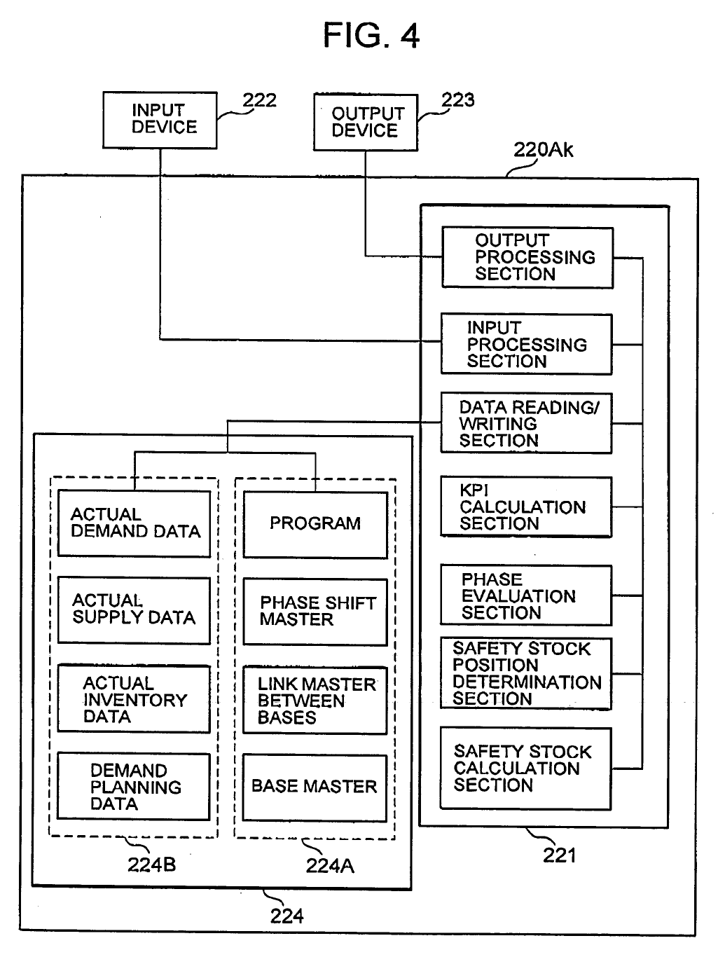

Among such subsystem 220A₁, 220A₂, . . . , 220Aₙ, at least one subsystem (here, one subsystem 220Aₖ) is a system which controls safety stock quantity of items at each base. Area on the auxiliary storage device 224 of this subsystem Aₖ is, as shown in FIG. 4, virtually divided into a code storage area 224A, and a data storage area 224B in which data renewal frequency is higher than that of the code storage area 224A, and data, which is necessary for control processing of safety stock quantity, is stored in each storage area 224A, 224B.

The code storage area 224A has stored an inventory control program for realizing inventory control processing which will be described later and a group of master data which is referred to in the inventory control processing which will be described later. Here, the group of master data includes the following master data (phase shift master data, link master data between bases, Base master data).

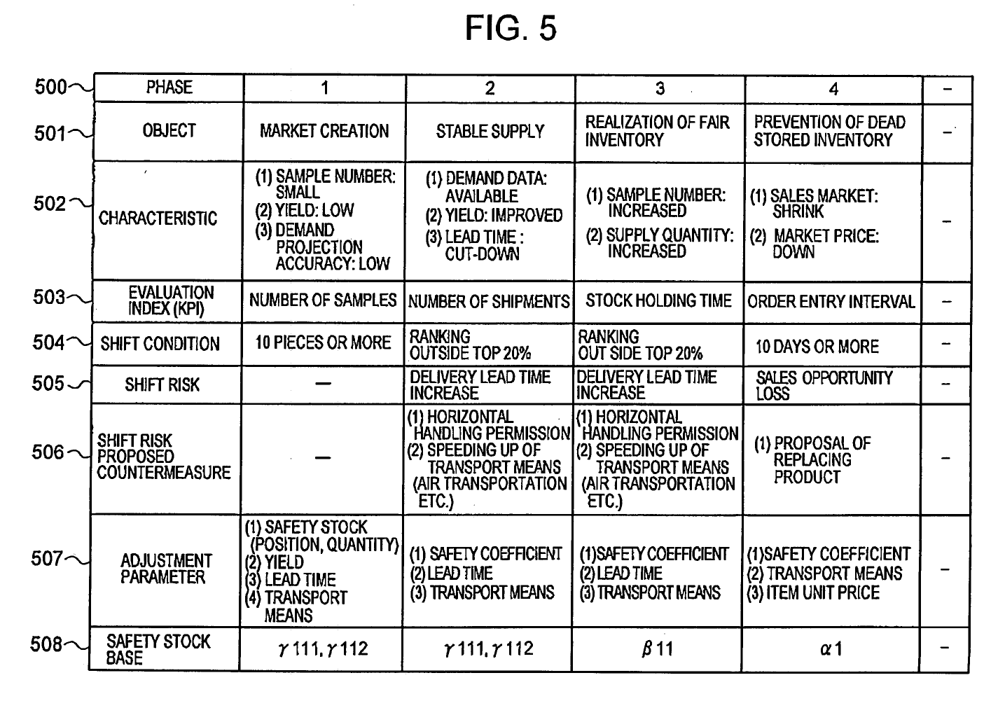

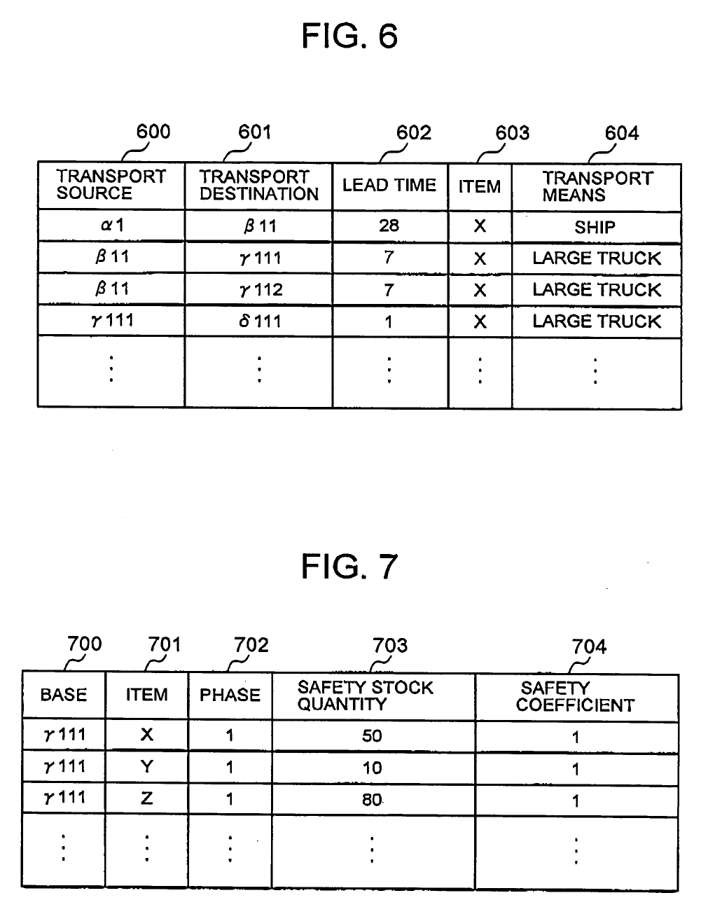

As shown in FIG. 5, the phase shift master data has stored phase shift information with respect to each phase of a life cycle of a managed item. Each phase shift information includes identification information of a phase (phase number) 500, object information 501 which represents an object of a phase, characteristic information 502 which represents a characteristic of a phase, a name (KPI name) of a parameter (Key Performance Indicator; hereinafter, referred to as KPI) which becomes an index showing that life cycle of a item shifts to a next phase, a condition (shift condition) 504 which should be satisfied by the evaluation index for shifting to a next phase, identification information (safety stock base name) 508 of a base in which a safety stock should be held (safety stock base) in this phase, a risk (shift risk) 505 which shift to a next phase involves, a proposed countermeasure to the shift risk (shift risk proposed countermeasure) 506, a parameter 507 which is adjustable by a user, and so on. Meanwhile, next to phase shift information of the fourth phase, phase shift information with a null value, which shows that a life cycle of circulation items is terminated, has been registered. FIG. 5 shows contents of phase shift master data for use in case that a life cycle of item is divided into the above-described first phase through the fourth phases as one example, but in case that a life cycle of item is divided into five or more phases, the number of registrations of phase shift information increases accordingly. As shown in FIG. 6, in the link master data between bases, link information is registered with respect to each link between bases. Each link information stores identification information of a transport source base (transport source base name) 600, identification information of a transport destination base (transport destination base name) 601, identification information of a transport target item (item number ) 603, lead time 602, a transport means name 604, and so on. For example, as to a link from a factory α1 to a distribution center β11, as the link information, a transport source base name “α1” 600, a transport destination base name “β11” 601, lead time “28 days” 603, a transport target item name “X” 602, and a transport means name “ship” 604 have been registered in link master data. Meanwhile, in case of also considering time required for movement in a base as lead time, link information, which includes the same base names for the transport source base name 600 and the transport destination base name 601, is registered in link master data. For example, in case that time for moving a item “X” by foot is “1 day” in a base “α1”, link information which includes the transport source base name 600 “α1”, the transport destination base name 610 “α1”, the item number 603 “X”, the lead time 602 “1 day”, and the transport means name 604 “foot”, may be registered. Alternatively, it may be configured so as to register a value to which moving time in a transport source base is also added, as the lead time 602 of each link information.

As shown in FIG. 7, in the base master data, base information has been registered with respect to each safety stock item which is possessed by a base. The base information stores identification information of a base (base name) 700, identification of a safety stock item (item number) 701, safety stock quantity 703, a safety coefficient 704, and so on. For example, in case that a base “γ111” is possessing three kinds of safety stocks “X”, “Y” and “Z”, as to the base “γ111”, base information with respect of each safety stock “X”, “Y” and “Z” is registered in base master data.

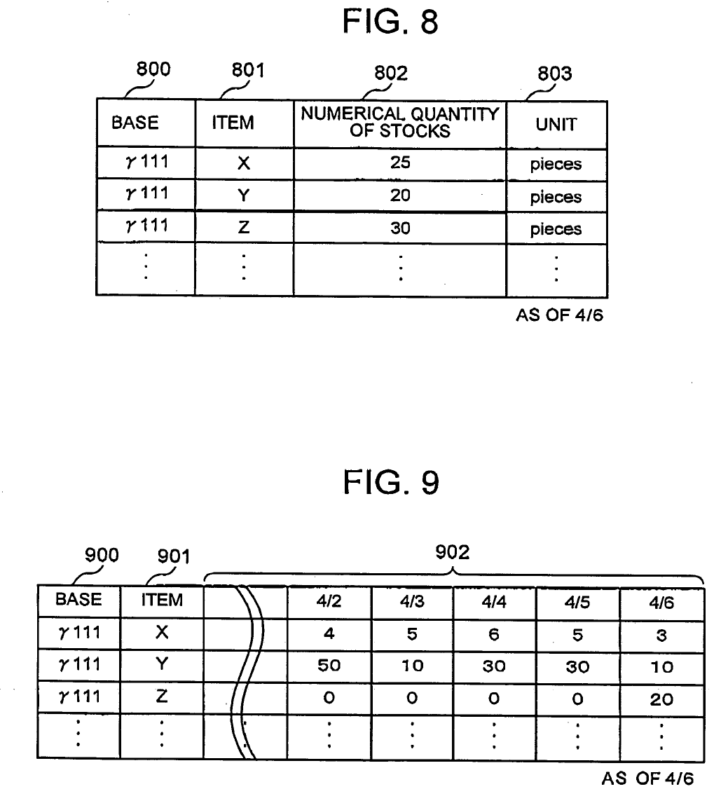

On one hand, the data storage area 224B, as shown in FIG. 4, has stored three kinds of actual data table (an actual demand data table which shows a demand status of items to date, an actual inventory data table which shows an inventory status of items to date, and an actual supply data table which shows a supply status of items to date) which are renewed gradually every other unit period (here, 1 day), a demand plan data table (not shown in the figure) which shows a demand status that is obtained as a result of demand projection, and an item management table. As shown in FIG. 8, in the actual inventory data table, actual inventory information at each base has been registered. Each actual inventory information has stored identification information of a base (base name) 800, identification information (item number) 801 of safety stock items which are possessed in the base, and inventory information (numerical quantity and a unit of numerical quantity) 802 of safety stock items. For example, in case that a base “γ111” is possessing three kinds of safety stock items “X”, “Y” and “Z”, as to the base “γ111”, inventory information with respect of each safety stock item “X”, “Y” and “Z” is registered in the inventory actual data table.

As shown in FIG. 9, in the actual demand data table, actual demand information has been registered with respect to each item. Each actual demand information has stored identification information (base name) 900 of a base which is possessing items, identification information (item number) 901 of an item, and demand quantity information 902 with respect to each unit period (e.g., 1 day) to date.

The demand plan data table has the same data configuration as that of the actual demand data table. In this table, however, instead of the demand quantity information 902, projected demand quantity information with respect to each unit period (e.g., 1 week) to date has been stored.

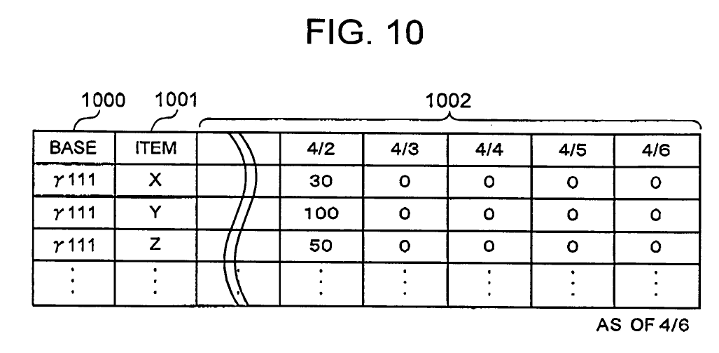

As shown in FIG. 10, in the actual supply data table, actual supply information has been registered with respect to each item, Each actual supply information has stored identification information (base name) 1000 that represents a supply destination base name of item, identification information (item number) 1001 of item, and supply quantity information 1002 with respect to each unit period to date.

The item management table has stored correspondence information of identification information of item (item number) and identification information of a current phase (phase number), with respect to each management target item.

By such hardware configuration and software configuration, the subsystem 220Aₖ realizes a functional configuration shown in FIG. 4. Concretely speaking, an information processing device realizes a data reading/writing section which carries out data reading/data writing processing to the data storage area 224B and the code storage area 224A, a KPI calculation section which calculates KPI on the basis of phase shift master data, a phase evaluation section which detects shift timing of a phase on the basis of KPI calculated by the KPI calculation section, a safety stock position determination section which determines a base for which safety stock should be renewed, a safety stock calculation section which calculates safety stock quantity of a base determined by the safety stock position determination section, in tune with shift timing of a phase, an output processing section which outputs information which should be presented to a user (evaluation result etc. of the phase evaluation section) to the output device 223, an input processing section which processes an instruction accepted by the input device 222 from auser, and soon, by execution of an inventory control program.

Meanwhile, in this embodiment, the case in which the inventory control system is realized by a general-purpose information processing device and software is cited as an example, but there is necessarily no need to do like this. For example, an inventory control system may be realized by hardware including hard-wired logic, or such hardware and a pre-programmed general-purpose information processing device.

In addition, in this embodiment, an inventory control program and a necessary data group have been installed in only one subsystem 220Aₖ, but the same inventory control program and necessary data group may be installed individually in a plurality of subsystems, or another subsystem may be configured to download the inventory control program and the necessary data group from the subsystem 220Aₖ according to need.

In addition, in this embodiment, one subsystem (an information processing device) 220Aₖ is realizing a function as an inventory control system, but a function of an inventory control system may be dispersed into a plurality of subsystems (a plural information processing devices).

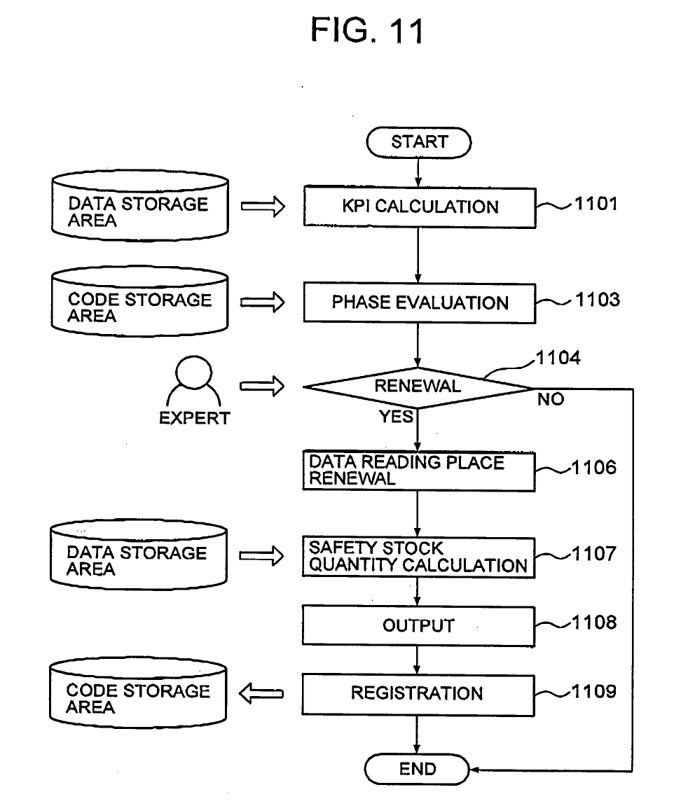

Next, by use of FIG. 11, processing, which is carried out by the inventory control system according to this embodiment, will be described.

The information processing device 220 of the subsystem 220A^{k} carries out the following inventory control processing, at predetermined timing (e.g., at regular intervals).

The data reading/writing section reads out each data table from the data storage area 224B and reads out each master data from code storage area 224A.

The KPI calculation section reads out all correspondence information from the item management table, and reads out phase shift information which includes the same phase number 500 as a phase number included in each correspondence information, from the phase shift master data. Then, the KPI calculation section calculates KPI, which is indicated by the KPI name 503 that is included in each phase shift information read out at this time, respectively (S1101).

For example, in case that correspondence information, which includes a phase number “1” and an item number “X”, is obtained, the KPI calculation section calculates a parameter “the number of total samples to date” which is indicated by a KPI name in phase shift information including the phase number “1”. Here, “the number of total samples to date” corresponds to, for example, a total value of entire quantity represented by the demand quantity information 902 which is associated with the item number “X”. In addition, in case that correspondence information, which includes an item number “X” and a phase number “2”, is obtained, the KPI calculation section calculates a parameter “the number of total shipments to date” indicated by a KPI name in phase shift information which includes the phase number “2”. Here, “the number of total shipments to date” corresponds to a total value of entire quantity represented by the supply quantity information 1002 which is associated with the item number “X”. In addition, in case that correspondence information, which includes an item number “X” and a phase number “3”, is obtained, the KPI calculation section calculates a parameter “stock holding time” indicated by a KPI name in phase shift information which includes the phase number “3”. Here, the “stock holding time” corresponds to time from the date up to now, the date being obtained on the condition that numerical quantity, which is represented by supply quantity information associated with the item number “X”, is sequentially subtracted, retroactively from present, from an added value of numerical quantity represented by the inventory information 802 associated with the item number “X”, and entire quantity represented by demand quantity information associated with the item number “X”, and the result of subtraction becomes equal to entire quantity represented by demand quantity information at present. In addition, in case that correspondence information, which includes an item number “X” and a phase number “4”, is obtained, the KPI calculation section calculates a parameter “order entry interval” indicated by a KPI name in phase shift information which includes the phase number “4”. Here, the “order entry interval” corresponds to the number of days passed from the final date, supply quantity of which represents a numerical value other than 0, in the supply quantity information 1002 associated with the item number “X”, to date.

In this way, when KPIs of all management target items are calculated, the phase evaluation section judges whether those KPIs satisfy the shift condition 504 of respective phase shift information, or not (S1103). At this time, in case that the shift condition 504 is a condition regarding a rank order of KPI (e.g., phases 2, 3), the phase evaluation section calculates the same parameter as that KPI, with regard to all management target items, in advance of judgment, and calculates a rank order of KPIs in those parameters.

In consequence, in case that there exists KPI which satisfies the shift condition 504, i.e., in case that there exists a management target item shifted to a next phase, the phase evaluation section outputs an item number and a message for prompting an input of renewal permission of safety stock quantity, as to that management target item, to the output device 223 through an output processing section.

Further, the shift risk 505, the shift risk proposed countermeasure 506 and an adjustment parameter 507 are read out from phase shift information including the shift condition 504 used for judgment in S1103, and they are also outputted to the output device 223 through the output processing section. Since a user can recognize the shift risk and the shift risk proposed countermeasure, by referring to these output information, it is possible to study adjustment of an adjustment parameter such as lead time, transport means, and safety coefficient α, in order to reduce a shift risk. Master data is renewed by an adjustment parameter value set up by a user here. For example, when a user inputs a safety coefficient α according to event probability of shortage to the input device, as to a certain management target item shifted to a next phase, the input processing section gives the inputted safety coefficient α to the data reading/writing section, and the data reading/writing section renews the corresponding safety coefficient 704 in base master data with that safety coefficient α. In the same way, when a user inputs lead time between bases (or, lead time in a base) to the input device, as to a certain management target item shifted to a next phase, the data reading/writing section renews the corresponding lead time 602 in link master data, with that lead time.

Here, when a user inputs a renewal rejection command to the input device 223 (S1104), the phase evaluation section terminates inventory control processing.

On one hand, when a user inputs a renewal permission command to the input device 223 (S1104), the input processing section instructs safety stock position determination to the safety stock position determination section, in response to that renewal permission command. In response to the instruction, the safety stock position determination section reads out the safety stock base name 508 from phase shift information of the shifted phase. Further, the safety stock calculation section calculates safety stock quantity of an item shifted to a next phase, with respect to each base which is represented by the safety stockbase name 508 (S1107). Concretely speaking, it is as follows.

The safety stock calculation section retrieves link information including the transport destination base name 601 corresponding to the safety stock base name, from link master data, and reads out the lead time 602 which is included in this link information. Here, if a transport source base name, which is included in the link information, indicates a factory, the safety stock calculation section sets up this lead time as supplying lead time, as to a base which is represented by the safety stock base name 508. On one hand, if a transport source base name, which is included in the link information, does not indicate a factory, the safety stock calculation section retrieves link information including the transport destination base name 601 corresponding to that transport source base name, from link master data, and reads out lead time which is included in this link information. The safety stock calculation section repeats the same processing until link information, which includes a factory as a transport source base name, is obtained, and when the link information, which includes a factory as a transport source base name, is obtained, it calculates a total value of every lead time. Then, the safety stock calculation section sets up the total value of lead time as supplying lead time, as to a base which is represented by the safety stock base name 508 (S1107).

After that, the safety stock calculation section calculates safety stock quantity of an item shifted to a next phase, by use of the supplying lead time set up as to a base which is represented by the safety stockbase name 508 (S1107). Meanwhile, a calculation formula of safety stock and details of calculation processing will be described later.

If safety stock quantity in each safety stock base is obtained as to all items shifted to a next phase, the safety stock calculation section outputs those safety stock quantities to the output device 223 through the output processing section (S1108).

After that, the data reading/writing section renews base information of an item shifted to a next phase, among base information stored in the base master data. That is, the data reading/writing section renews the phase number 702 and safety stock quantity 703 of base information which includes the item number 702 of an item shifted to a next phase, by use of a phase number of a next phase and safety stock quantity calculated in S1107 (S1109).

Meanwhile, in the foregoing, it is determined by a user whether renewal of safety stock quantity is to be carried out or not, adjustment of an adjustment parameter is to be carried out or not, but there is necessarily no need to do in this way. For example, it may be configured in such a manner that safety stock quantity is renewed automatically when shift of a phase is detected, without requesting a user for renewal permission of safety stock quantity, or without accepting adjustment of an adjustment parameter from a user.

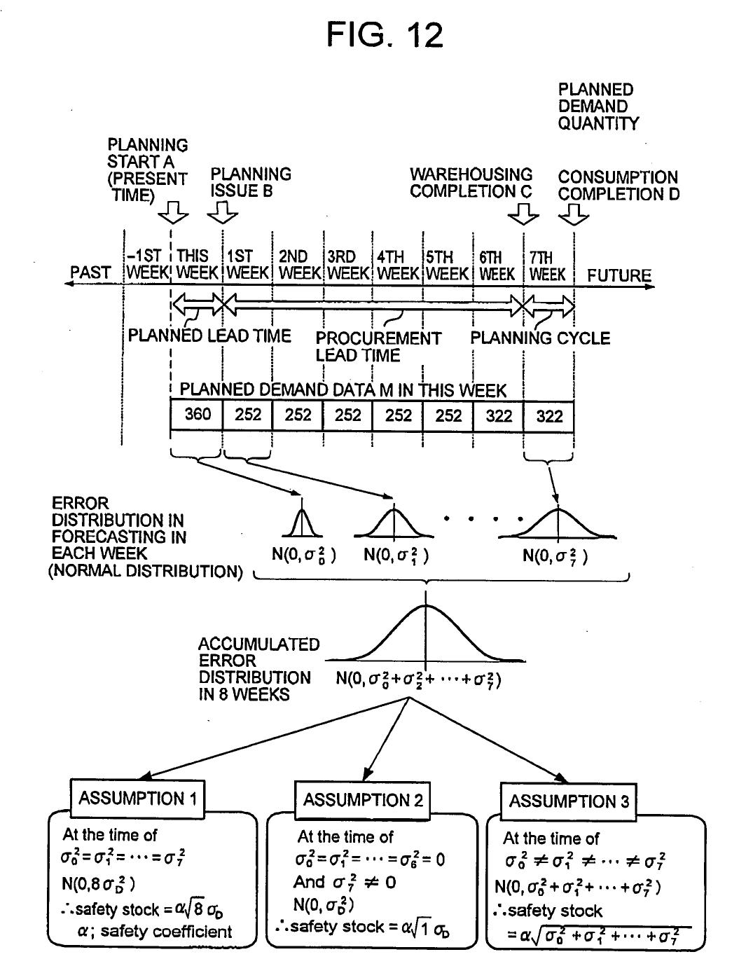

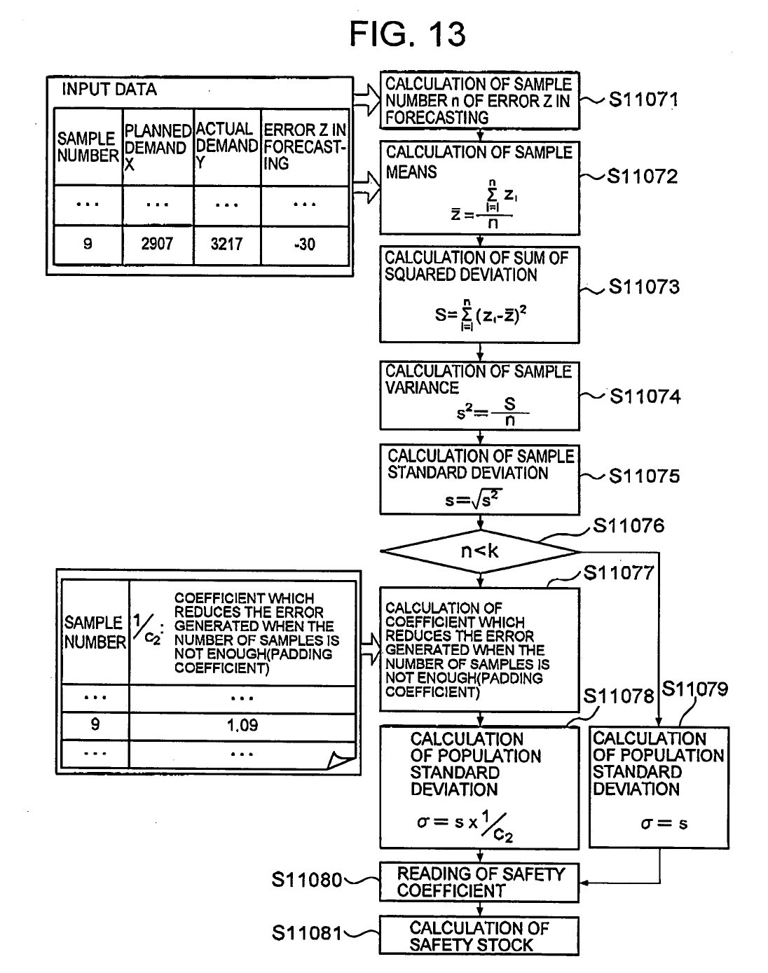

Next, a calculation formula of safety stock quantity and calculation processing of safety stock quantity by use of this calculation formula will be described by use of FIGS. 12 and 13.

(1) Calculation Formula of Safety Stock

Here, a case, in which planning lead time is set up to 1 week and supplying lead time is set up to 6 weeks and a planning cycle is set up to 1 week, is cited as an example.

As shown in FIG. 12, assuming that a head of a week including a current date (hereinafter, referred to as this week) is a starting day A of planning, an issue date B of the prepared plan becomes a head of a first week, and a warehousing completion date C becomes an end of a sixth week, and a consumption completion date D of planned demand quantity at present becomes an end of a seventh week. The planned demand quantity M at present includes data (this week; 360, first week: 252, second week: 252, third week: 252, fourth week: 252, fifth week: 252, sixth week: 322, seventh week: 322) which represents planned demand quantity in each week within a planned range (a period from this week up to a final week). Here, it is assumed that a difference between actual demand quantity and planned demand quantity in each week (error in forecasting) is in accordance with normal distribution N (0, σ²).

For example, in case that variance values (σ₀ through σ₇) of error distributions in forecasting in respective weeks are equivalent, a relation of a variance value σ_{D} in an accumulated error distribution and safety stock quantity, within a planned range, is represented by the following formula 2 (assumption 1 of FIG. 12).
At the time of σ₀²=σ₁²=σ₂²= . . . =σ₇²
safety stock=α\sqrt{8}σ_{D} (2)
α; safety coefficient

However, a variance value a of an error in forecasting may vary every week. For example, in case that demands from this week up to the sixth week are fixed (i.e., in case that variance values σ₀ through σ₆ in respective weeks from this week up to the sixth week are 0, and a variance value σ₇ in the seventh week is not 0), a relation of the variance value σ_{D} of an accumulated error distribution 1001 and safety stock quantity, within the planned range, is represented by the following formula 3 (assumption 2 of FIG. 12).
At the time of σ₀²=σ₁²=σ₂²= . . . =σ₆²=0 and σ₇²=0
safety stock=α\sqrt{1}σ_{D} (3)
α; safety coefficient

In addition, in case that a variance value in each week in the planned range is not 0, and they are not equivalent each other, a relation of a variance value σ_{D} in an accumulated error distribution and safety stock quantity, within a planned range, is represented by the following formula 4 (assumption 3 of FIG. 12).
At the time of σ₀²≠σ₁²≠σ₂²≠ . . . ≠σ₇²
safety stock=α\sqrt{α₀²+α₁²+ . . . +α₇²} (4)

The formula 4 is a general-purpose formula which contains the formulas 2, 3 in the assumptions 1, 2. Then, in this embodiment, safety stock quantity is to be calculated by use of the formula 4 of the assumption 3.

(2) Calculation Processing of Safety Stock Quantity (S1107)

FIG. 13 is a flow chart of calculation processing (S1107) of safety stock quantity.

The safety stock calculation section calculates a sample number n of a difference (error Z in forecasting) between numerical quantity shown by demand quantity information in actual demand information and numerical quantity shown by planned demand information in planned demand information (S11071), and calculates sample mean of that sample n (S11072) Further, the safety stock calculation section calculates a sum S of squared deviation (S11073), and calculates a sample variance value s² from the obtained sum S of squared deviation (S11074). After that, the safety stock calculation section calculates sample standard deviation s from the sample variance value s² (S11705).

After that, the safety stock calculation section judges whether the sample number n of the error Z in forecasting is a predetermined threshold value k or more or not (S11706).

In consequence, if the sample number n of the error Z in forecasting is the threshold value k or more, the safety stock calculation section sets up the sample standard deviation s calculated in S11705, to population standard deviation σ (S11709).

On one hand, if the sample number n is less than the threshold value k, the safety stock calculation section reads out a coefficient 1/c₂ which reduces the error generated when the number of samples is not enough, from the previously retained correspondence information (in this regard, however, c₂>1) associated with the sample number n calculated in S11071 (S11077), and calculates a product (1/c₂)×s of this coefficient 1/c₂ and sample standard deviation s, as the population standard deviation σ (S11078). The reason why a coefficient which reduces the error generated when the number of samples is not enough is used, in this manner, is that there is the trend that the sample standard deviation s becomes smaller than the population standard deviation σ when the number of samples is not enough.

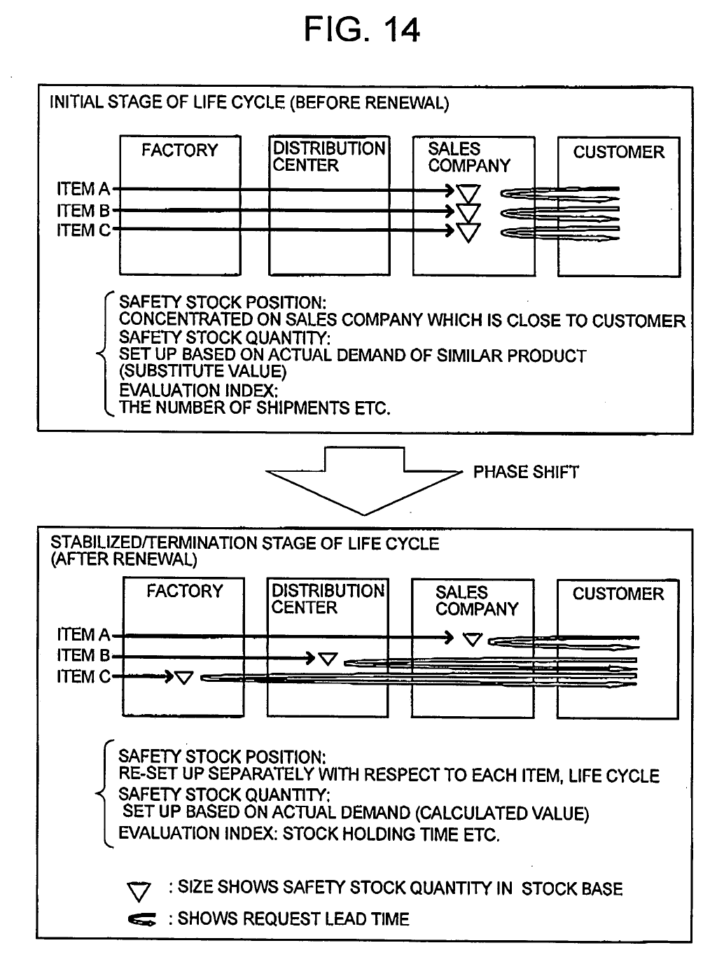

After that, the data reading/writing section reads out a safety coefficient a which corresponds to an item number of an item shifted to a next phase and a safety stock base name, from the base master data, and gives this over to the safety stock calculation section (S11080). The safety stock calculation section calculates a product α×σ of that safety coefficient α and the population standard deviation σ as safety stock quantity (S11081). This multiplication formula α×σ is equivalent to the safety stock quantity calculation formula (4) of the assumption 3. According to such safety stock quantity calculation processing, when a phase is shifted as shown in FIG. 14, safety stock quantity is re-set up by use of data which is appropriate for a shifted phase, as to a base in which safety stock should be possessed in the shifted phase. On this account, in respective stages of a life cycle of items, it is possible to obtain more appropriate safety stock quantity, respectively, and in consequence, it is possible to suppress stock excess or shortage of items, through a life cycle.

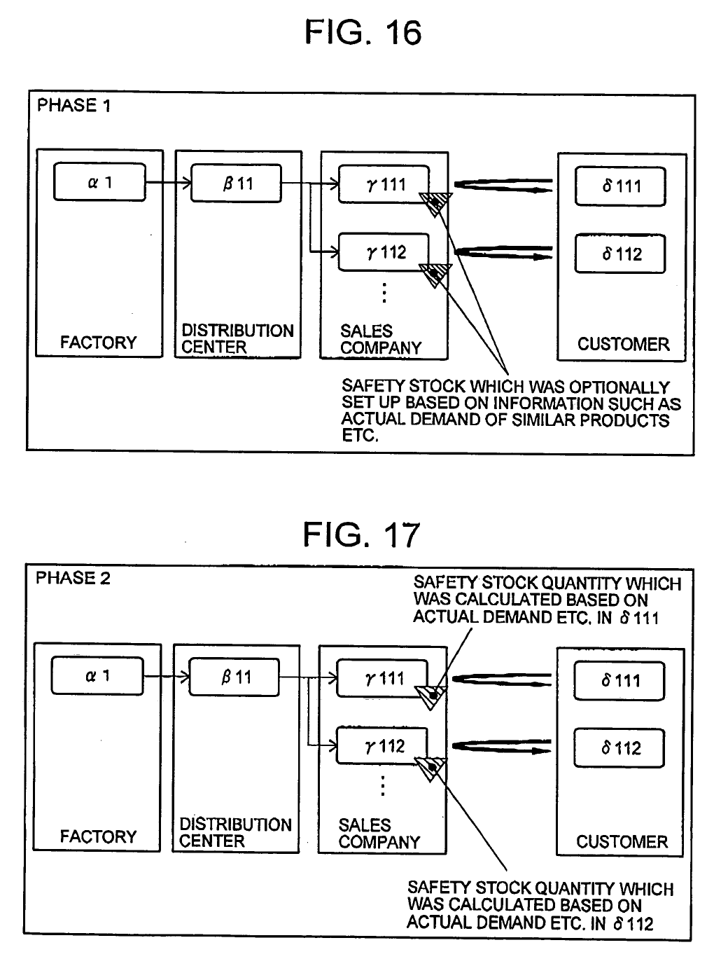

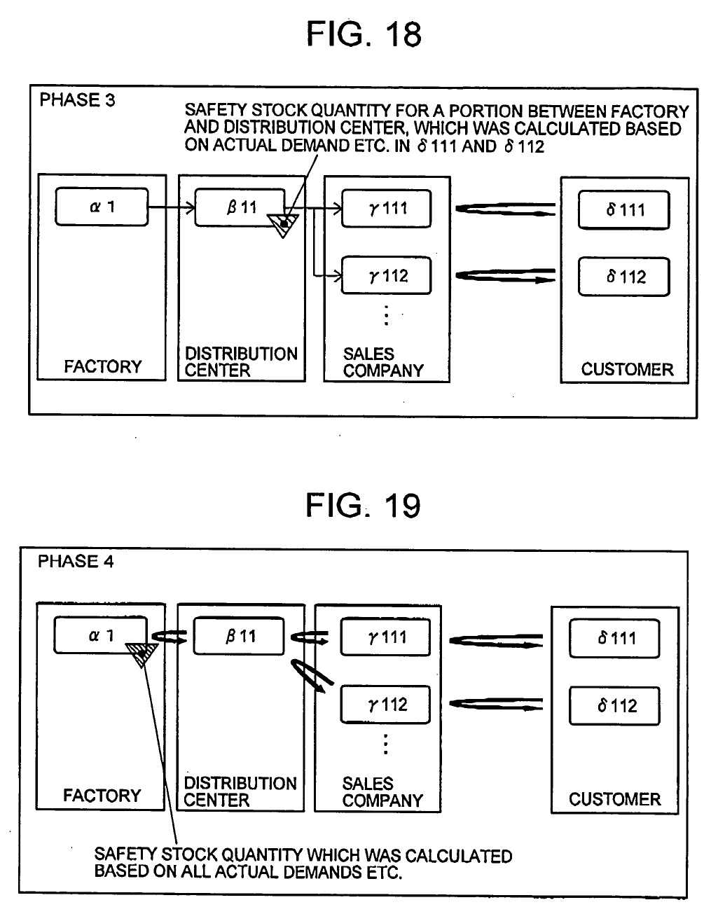

For example, as shown in FIG. 16, in the first phase, safety stock quantity is set up in a sales company on the basis of actual demand etc. of similar products, but at the time of shifting to the second phase, safety stock quantity, which is appropriate for the second phase, is re-set up to a sales company defined as a safety stock base in the second phase as shown in FIG. 17, by carrying out the above-described safety stock quantity calculation processing through the use of the phase shift master data of FIG. 5. In addition, at the time of shifting to the third phase, safety stock quantity, which is appropriate for the third phase, is re-set up to a distribution center and a sales company defined as safety stock bases in the third phase as shown in FIG. 18, by carrying out the above-described safety stock quantity calculation processing through the use of the phase shift master data of FIG. 5. Further, at the time of shifting to the fourth phase, safety stock quantity, which is appropriate for the fourth phase, is re-set up to a factory defined as a safety stock base in the fourth phase as shown in FIG. 19, by carrying out the above-described safety stock quantity calculation processing through the use of the phase shift master data of FIG. 5. Meanwhile, FIGS. 14 through 19 show a change of a safety stock base in case of using registered contents of phase shift master data of FIG. 5, but a safety stock base in each phase is to be changed accordingly if registered contents of the phase shift master data are changed.

Finally, an application example of the inventory control system according to this embodiment will be cited.

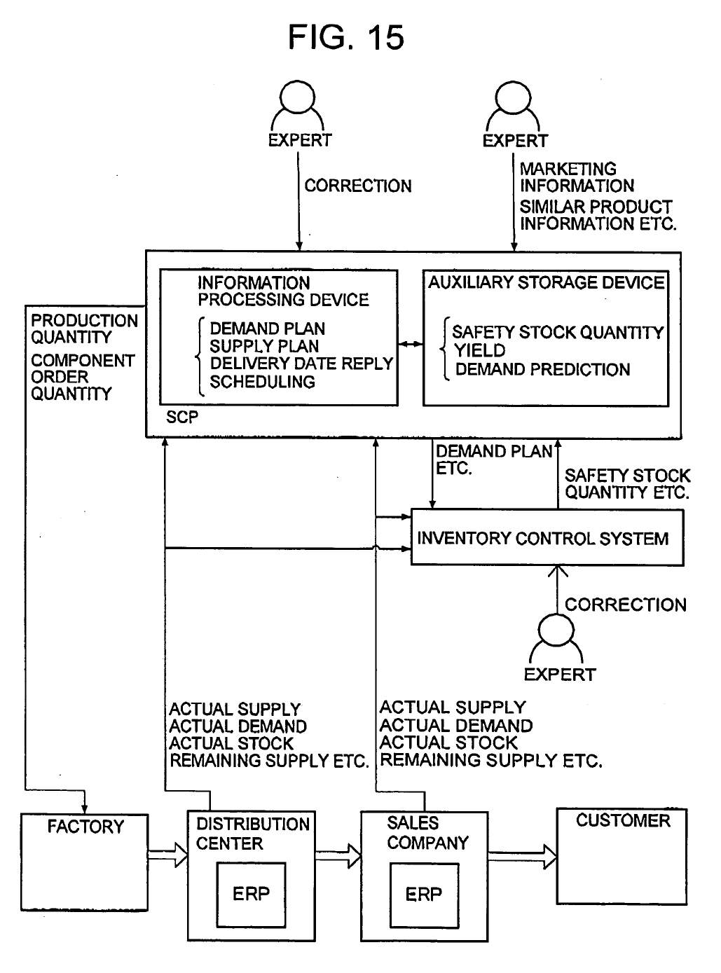

As an information processing system which begins to be used in business organizations, there are a supply chain planning system (hereinafter, referred to as SCP) and an enterprise resource planning system (hereinafter, referred to as ERP). The former has functions of demand planning, supply planning, delivery data reply, scheduling and so on, and the latter has functions of inventory control and so on. For example, as shown in FIG. 15, the inventory control system, which relates to this embodiment, exists between SCP and ERP, and can function as a system which is in a so-called intermediate position between SCP and ERP.

What is claimed is:

1. An inventory control system which manages inventory quantity of circulation item at a base, comprising:
storing means in which phase identification information representing a current phase of the circulation item, and a shift condition to each phase in a life cycle of the circulation item are stored,
arithmetic processing means which calculates an index for judging that a phase, which is represented by the phase identification information, is shifted to its next phase, from actual data regarding circulation of the circulation item, and compares the index with the shift condition, and detects a change of a phase of the circulation item, in case that the index satisfies the shift condition, and
input accepting means which accepts an input of renewal permission of safety stock quantity of the circulation item, in case that the arithmetic processing means detected the change,
wherein
the arithmetic processing means
executes renewal of the phase identification information which is stored in the storing means, by phase identification information which represents a shifted phase, and calculation of safety inventory quantity of the circulation item, in the shifted phase, as to the base, when the input accepting means accepts the input of renewal permission.

2. The inventory control system as set forth in claim 1, comprising:
output processing means which outputs, in case that the arithmetic processing means detected the change, information regarding the shifted phase,
wherein
the input accepting means accepts an input of a parameter for use of calculation of the safety inventory quantity, and for changing a size of the safety stock quantity, and
the arithmetic processing means calculates the safety stock quantity by use of the parameter accepted by the input accepting means.

3. An inventory control method which has an information processing device carried out calculation processing of safety stock quantity at a base, wherein
the information processing device comprises
storing means in which phase identification information representing a current phase of circulation item, and a shift condition to each phase in a life cycle of the circulation item are stored,
arithmetic processing means, and
input accepting means,
the inventory control method comprising;
processing of calculating an index which is used for the arithmetic processing means to judge that a phase, which is represented by the phase identification information, is shifted to a next phase, from actual data regarding circulation of the circulation item, and compares the index with a shift condition, and detects a change of a phase of the circulation item, in case that the index satisfies the shift condition,
processing of the input accepting means accepting an input of renewal permission of safety stock quantity of the circulation item, in case that the arithmetic processing means detected the change, and
processing of executing renewal of the phase identification information stored in the storing means, by phase identification information which represents a shifted phase, and calculation of safety inventory quantity of the circulation item, in the shifted phase, as to the base, when the input accepting means accepts the input of renewal permission.

4. The inventory control method as set forth in claim 3, wherein.
the information processing device further comprises output processing means,
the inventory control method comprising:
processing of the output processing means outputting information regarding a next phase, in case that the arithmetic processing means detected the change, and
processing of the input accepting means accepting an input of a parameter for use of calculation of the safety stock quantity and for changing a size of the safety stock quantity, wherein
the arithmetic processing means calculates the safety stock quantity by use of the parameter accepted by the input accepting means.

5. A program which has an information processing device execute calculation processing of safety stock quantity at a base, wherein
the information processing device comprises
storing means in which phase identification information representing a current phase of circulation item, and a shift condition to each phase in a life cycle of the circulation item are stored,
arithmetic processing means, and
input accepting means,
the program comprising logic of dictating, to the information processing device,
processing of calculating an index which is used for the arithmetic processing means to judge that a phase, which is represented by the phase identification information, is shifted to a next phase, from actual showing data regarding circulation of the circulation item, and compares the index with a shift condition, and detects a change of a phase of the circulation item, in case that the index satisfies the shift condition,
processing of the input accepting means accepting an input of renewal permission of safety stock quantity of the circulation item, in case that the arithmetic processing means detected the change, and
processing of executing renewal of the phase identification information stored in the storing means, by phase identification information which represents a shifted phase, and calculation of safety inventory quantity of the circulation item, in the shifted phase, as to the base, when the input accepting means accepts the input of renewal permission.

6. The program as set forth in claim 5, wherein
the information processing device further comprises output processing means,
the program further comprising losic of dictating, to the information processing device,
processing of the output processing means outputting information regarding a next phase, in case that the arithmetic processing means detected the change, and
processing of the input accepting means accepting an input of a parameter for use of calculation of the safety stock quantity and for changing a size of the safety stock quantity, wherein
the arithmetic processing means calculates the safety stock quantity by use of the parameter accepted by the input accepting means.

7. A computer readable storage medium in which the program as set forth in claim 5 is stored.
